(19) United States
(12) Patent Application Publication
(10) Pub. No.: US 2025/0328277 A1
(43) Pub. Date: Oct. 23, 2025

(54) MULTI-PLANE FIRMWARE IMAGE MANAGEMENT

(71) Applicant: Micron Technology, Inc., Boise, ID (US)

(72) Inventors: Xing Wang, Shanghai (CN); Deping He, Boise, ID (US); Shen Wu, Shanghai (CN); Jianfeng Li, Shanghai (CN); Jiawei Wang, Shanghai (CN)

(21) Appl. No.: 19/098,752

(22) Filed: Apr. 2, 2025

Related U.S. Application Data
(60) Provisional application No. 63/635,985, filed on Apr. 18, 2024.

(51) Int. Cl. G06F 3/06

(52) U.S. Cl. CPC G06F 3/0655; G06F 3/0625; G06F 3/0679

(57) ABSTRACT

Methods, systems, and devices for multi-plane firmware image management are described. A memory system may store a primary firmware image across multiple planes. The memory system may read the firmware image from the planes using a multi-plane read operation. The memory system may store copies of the firmware image to separate, individual planes and the copies may be accessed (e.g., read) based on detecting an error in the primary firmware image.

### CROSS REFERENCE

The present Application for Patent claims priority to U.S. Patent Application No. 63/635,985 by Wang et al., entitled “MULTI-PLANE FIRMWARE IMAGE MANAGEMENT,” filed Apr. 18, 2024, which is assigned to the assignee hereof, and which is expressly incorporated by reference in its entirety herein.

### TECHNICAL FIELD

The following relates to one or more systems for memory, including multi-plane firmware image management.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports multi-plane firmware image management in accordance with examples as disclosed herein.

FIG. 2 shows an example of a firmware image configuration that supports multi-plane firmware image management in accordance with examples as disclosed herein.

FIG. 3 shows an example of a process that supports multi-plane firmware image management in accordance with examples as disclosed herein.

FIG. 4 shows a block diagram of a memory system that supports multi-plane firmware image management in accordance with examples as disclosed herein.

FIG. 5 shows a flowchart illustrating a method or methods that support multi-plane firmware image management in accordance with examples as disclosed herein.

### DETAILED DESCRIPTION

Some memory systems may store a firmware image that is associated with aspects of an initialization or bootup sequence. In some examples, a firmware image may be stored in a plane (e.g., a single plane) of the memory system, and one or more copies or backups of the firmware image may be similarly stored in other planes (e.g., a single backup may be stored in a single plane). The memory system, in response to receiving a power-on or restart command, may access the stored firmware image and may use it to boot-up or initialize various components and operations of the memory system. For example, the memory system may read the firmware image from the plane of memory in a sequential order (e.g., one block at a time). However, reading the firmware image from a single plane may utilize more time than reading the firmware image from multiple planes in parallel. Accordingly, a memory system configured to reduce latency associated with loading (e.g., reading) a firmware image may be desirable.

A memory system configured to reduce latency associated with loading (e.g., reading) a firmware image is described herein. To reduce the latency associated with reading a firmware image, the memory system may store the firmware image across multiple planes such that, during a power-on or boot-up process, the memory system may read the stored firmware using a multi-plane read. A multi-plane read may be relatively faster than reading the firmware image from a single plane. Further, the memory system may store each copy (e.g., each backup) of the firmware image to separate planes (e.g., to a respective single plane). Thus, if an error is in the firmware image that is stored across multiple planes and is detected during the multi-plane read, the memory system may read a backup copy (or backup copies) of the firmware image that is stored in a single plane. Accordingly, storing and accessing a firmware image as described herein may reduce the latency associated with a boot-up or power-on procedure, which may improve the overall performance of the associated memory system.

In addition to applicability in memory systems as described herein, techniques for multi-plane firmware image management may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

Features of the disclosure are illustrated and described in the context of systems, devices, and circuits. Features of the disclosure are further illustrated and described in the context of firmware image configurations, processes, and flowcharts.

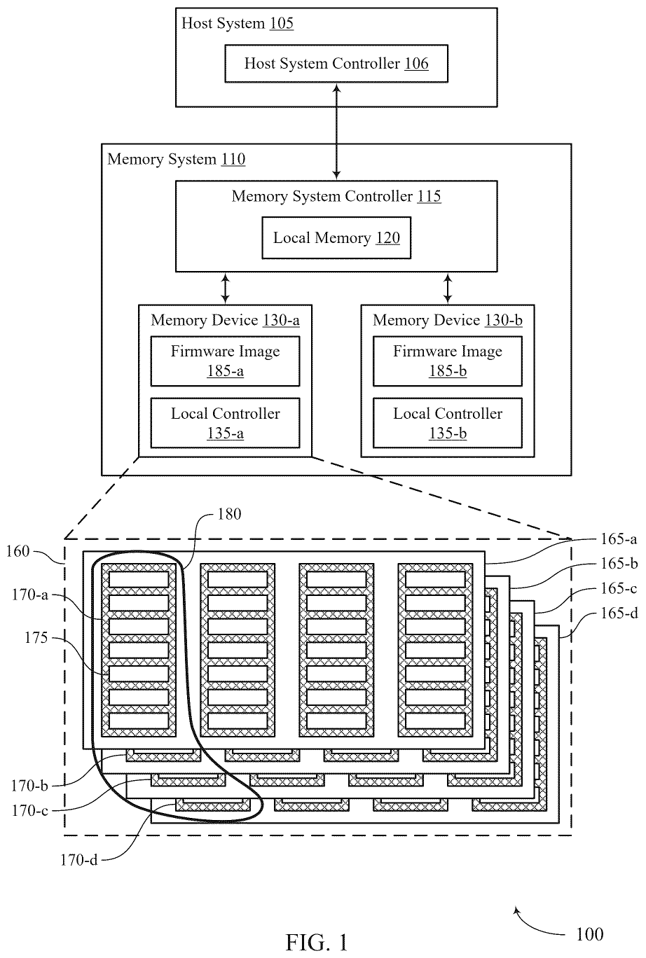

FIG. 1 shows an example of a system 100 that supports multi-plane firmware image management in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may include (e.g., store) a firmware image 185 (e.g., a firmware image 185-a, a firmware image 185-b). The firmware image 185 may refer to software stored within the memory system 110 that may represent the current operating system, user data, client information, and other data of the memory system 110 that may be utilized in a bootup or power-on operation of the memory system 110. The firmware image 185 may be stored to the memory system 110 and may be accessed by the memory system controller 115. For example, in the case of a bootup (e.g., power-on) event, the memory system controller 115 may access the firmware image 185. In some examples, while loading the firmware image 185, the memory system 110 may perform a validation or error detection operation to ensure that the firmware image 185 is loaded correctly. For example, the memory system controller 115 may compare a hash (e.g., a file hash) of the accessed firmware image 185 to an expected hash value to generate a checksum for the firmware image 185, which the memory system 110 may utilize to determine the validity of the firmware image 185. In response to determining that the firmware image 185 is valid (e.g., the firmware image 185 has not been corrupted), the memory system 110 may utilize the firmware image 185 to load operable data and perform the correct bootup operations.

To reduce the latency associated with reading the firmware image 185, the memory system 110 may store the firmware image 185 across multiple planes 165 such that, during a power-on or boot-up process, the memory system 110 may read the stored firmware image 185 using a multi-plane read, which may be relatively faster than reading the firmware image 185 from a single plane 165. Further, the memory system 110 may store each copy (e.g., each backup) of the firmware image 185 to separate planes 165 (e.g., to a respective single plane 165). Thus, if an error is detected during the multi-plane read, the memory system 110 may read a backup copy (or backup copies) of the firmware image 185 from a single plane 165. Accordingly, storing and accessing the firmware image 185 as described herein may reduce the latency associated with a boot-up or power-on procedure, which may improve the overall performance of the memory system 110.

The system 100 may include any quantity of non-transitory computer readable media that support multi-plane firmware image management. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

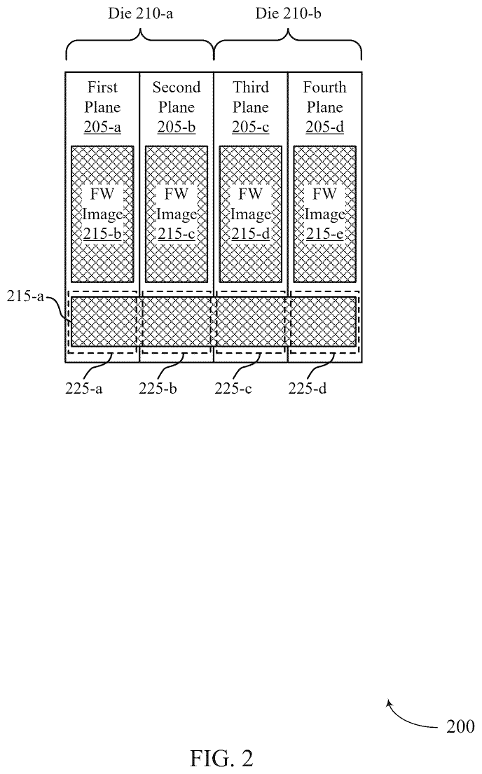

FIG. 2 shows an example of a firmware image configuration 200 that supports multi-plane firmware image management in accordance with examples as disclosed herein. The firmware image configuration 200 may be implemented by a system 100 as described with reference to FIG. 1, or aspects thereof (e.g., a memory system controller 115). The firmware image configuration 200 may include a first plane 205-a, a second plane 205-b, a third plane 205-c, and a fourth plane 205-d, which may be examples of the planes 165 as illustrated in FIG. 1. In some instances, the first plane 205-a and the second plane 205-b may be associated with a first memory die 210-a, and the third plane 205-c and the fourth plane 205-d may be associated with a second memory die 210-b, which may each be examples of the dies 160 as described with reference to FIG. 1.

To decrease bootup latency, a memory system may store a first firmware image 215-a (e.g., a primary firmware image) across the planes 205 such that, during a power-on or boot-up process, the memory system may quickly access and read the first firmware image 215-a from the planes 205 using a multi-plane read. For example, the memory system may store the first firmware image 215-a across the first plane 205-a, the second plane 205-b, the third plane 205-c, and the fourth plane 205-d (e.g., and thus across the dies 210) of the memory system. During a power-on or boot-up procedure, the memory system may read the first firmware image 215-a from the planes 205 sequentially, such that the overall duration to power-on or boot-up the memory system may be relatively less than if the first firmware image was stored to and read from a single plane 205.

In some examples, the memory system may also store copies (e.g., backups) of the first firmware image 215-a to separate, individual planes 205 such that the firmware image copies may be utilized in a case that the first firmware image 215-a may include an error or during a reprogramming operation of the memory system. For example, the second firmware image 215-b, the third firmware image 215-c, the fourth firmware image 215-d, and the fifth firmware image 215-e may be copies of (e.g., may include the same data as) the first firmware image 215-a and may be stored to the first plane 205-a, the second plane 205-b, the third plane 205-c, and the fourth plane 205-d, respectively.

The memory system (e.g., or a memory system controller thereof) may transition power states and read the first firmware image 215-a. For example, during a boot operation (e.g., a boot-up, power-on) operation, the memory system controller may transition the memory system from a first power state to a second power state. In some examples, the first power state may be or may refer to a relatively low power state, such as a powered-off state, and the second power state may be or may refer to a relatively higher power state, such as a powered-on state. In response to transitioning power states, the memory system controller may read the first firmware image 215-a from the first plane 205-a, the second plane 205-b, the third plane 205-c, and the fourth plane 205-d of the memory system using a multi-plane read.

To read the first firmware image 215-a from the planes 205, the memory system controller may read portions 225 of the first firmware image 215-a from the planes 205. For example, the memory system controller may read a first portion 225-a of the first firmware image 215-a from the first plane 205-a, followed by a second portion 225-b of the first firmware image 215-a from the second plane 205-b, a third portion 225-c of the first firmware image 215-a from the third plane 205-c, and a fourth portion 225-d of the first firmware image 215-a from the fourth plane 205-d. The memory system may then operate according to the first firmware image 215-a.

In some examples, the memory system may utilize one or more of the copies of the first firmware image 215-a (e.g., the second firmware image 215-b, the third firmware image 215-c, the fourth firmware image 215-d, the fifth firmware image 215-e) during the bootup operation. For example, while reading the first firmware image 215-a, the memory system controller may determine that the first firmware image 215-a does not satisfy an error threshold. That is, the memory system controller may determine (e.g., identify) one or more errors associated with the first firmware image 215-a. In some examples, the memory system controller may determine whether the first firmware image 215-a satisfies the error threshold or not by comparing a hash of the first firmware image 215-a with an expected hash and determining whether the hashes match.

In the case that the compared hashes do match (e.g., are the same), an error may not be included in the first firmware image 215-a (e.g., the error threshold may be satisfied) and the memory system may utilize (e.g., load) the first firmware image 215-a. In the case, however, that the compared hashes do not match (e.g., are not the same), an error may be included in the first firmware image 215-a (e.g., the error threshold may not be satisfied) and the memory system may utilize (e.g., load) one or more of the copies of the first firmware image 215-a. In the case that the first firmware image 215-a does not satisfy the error threshold, the memory system controller may access one or more backup versions of the first firmware image 215. For example, in response to the memory system controller determining that the first firmware image 215-a may not satisfy the error threshold, the memory system controller may read the second firmware image 215-b stored to the first plane 205-a.

Upon reading the second firmware image 215-b, the memory system controller may determine whether the second firmware image 215-b satisfies the error threshold. If the memory system controller determines that the second firmware image 215-b satisfies the error threshold, the memory system controller may load the second firmware image 215-b and operate the memory system according to the second firmware image 215-b. If, however, the memory system controller determines that the second firmware image 215-b does not satisfy the error threshold, the memory system controller may keep reading firmware image copies until the memory system controller determines that one does satisfy the error threshold (e.g., does not include an error). That is, the memory system controller may read one or more of the firmware image copies (e.g., the second firmware image 215-b, the third firmware image 215-c, the fourth firmware image 215-d, the fifth firmware image 215-e) sequentially until the memory system controller determines one of the firmware image copies to satisfy the error threshold, and the memory system may operate according to that firmware image copy.

In some cases, the firmware image 215-a may be updated. For example, a change may be made to user information or other data associated with the firmware images 215-a, and the memory system may update the firmware images 215-a. To update the firmware image 215-a, the memory system controller may receive a command from a host system which may indicate an update to be made. In response to receiving the command, the memory system controller may first program the second firmware image 215-b stored to the first plane 205-a and the fifth firmware image 215-e stored to the fourth plane 205-d. In some examples, updating the second firmware image 215-b and the fifth firmware image 215-e may include erasing the original second firmware image 215-b and original fifth firmware image 215-e, storing placeholder data to the first plane 205-a and the fourth plane 205-d, and programming a new second firmware image 215-b and a new fifth firmware image 215-e to the first plane 205-a and the fourth plane 205-d. In some examples, the memory system controller may store a quantity of placeholder data corresponding to a reliability parameter of the memory system.

Upon programming the second firmware image 215-b and the fifth firmware image 215-e, the memory system controller may restart the memory system using the reprogrammed second firmware image 215-b. For example, based on programming the second firmware image 215-b and the fifth firmware image 215-e, the memory system controller may transition the power state of the memory system from the second power state to the first power state and back to the second power state (e.g., the memory system controller may restart the memory system). After restarting the memory system, the memory system controller may read the second firmware image 215-b until the first firmware image 215-a is updated.

The memory system may program the third firmware image 215-c and the fourth firmware image 215-d. For example, in response to restarting the memory system, the memory system controller may program the third firmware image 215-c stored to the second plane 205-b and the fourth firmware image 215-d stored to the third plane 205-c. In some examples, updating the third firmware image 215-c and the fourth firmware image 215-d may include erasing the original third firmware image 215-c and original fourth firmware image 215-d, storing placeholder data to the second plane 205-b and the third plane 205-c, and programming a new third firmware image 215-c and a new fourth firmware image 215-d to the second plane 205-b and the third plane 205-c.

The memory system may program (e.g., update) the first firmware image 215-a. For example, in response to programming the second firmware image 215-b, the third firmware image 215-c, the fourth firmware image 215-d, and the fifth firmware image 215-e, the memory system controller may program the first firmware image 215-a. In some examples, programming the first firmware image 215-a may include the memory system controller updating respective portions of the first firmware image 215-a stored to each of the first plane 205-a, the second plane 205-b, the third plane 205-c, and the fourth plane 205-d. For example, the memory system controller may update the first portion 225-a of the first firmware image 215-a stored to the first plane 205-a, the second portion 225-b of the first firmware image 215-a stored to the second plane 205-b, the third portion 225-c of the first firmware image 215-a stored to the third plane 205-c, and the fourth portion 225-d of the first firmware image 215-a stored to the fourth plane 205-d.

As shown in FIG. 2, the first firmware image 215-a (e.g., and the associated copies) are illustrated (e.g., in the firmware image configuration 200) as being stored to one or more planes 205. That is, the first firmware image 215-a is illustrated as being stored to the first plane 205-a, the second plane 205-b, the third plane 205-c, and the fourth plane 205-d. The second firmware image 215-b is illustrated as being stored to the first plane 205-a, the third firmware image 215-c is illustrated as being stored to the second plane 205-b, the fourth firmware image 215-d is illustrated as being stored to the third plane 205-c, and the fifth firmware image 215-d is illustrated as being stored to the fourth plane 205-d. However, in other examples, other quantities of planes 205 may be utilized. Additionally, or alternatively, while FIG. 2 illustrates two dies 210 being utilized, the firmware images 215 may be stored to (or across) any quantity of dies 210.

By storing the first firmware image 215-a across the planes 205, the memory system may quickly access and read the first firmware image 215-a from the planes 205 during a boot-up or power-on operation, which may reduce the latency associated with a boot-up or power-on procedure and improve the overall performance of the associated memory system. Additionally, by storing copies of the first firmware image 215-a (e.g., the second firmware image 215-b, the third firmware image 215-c, the fourth firmware image 215-d, the fifth firmware image 215-e) to respective planes 205, the memory system controller may be able to continue operations in the case that the first firmware image 215-a may include an error or during a reprogramming operation.

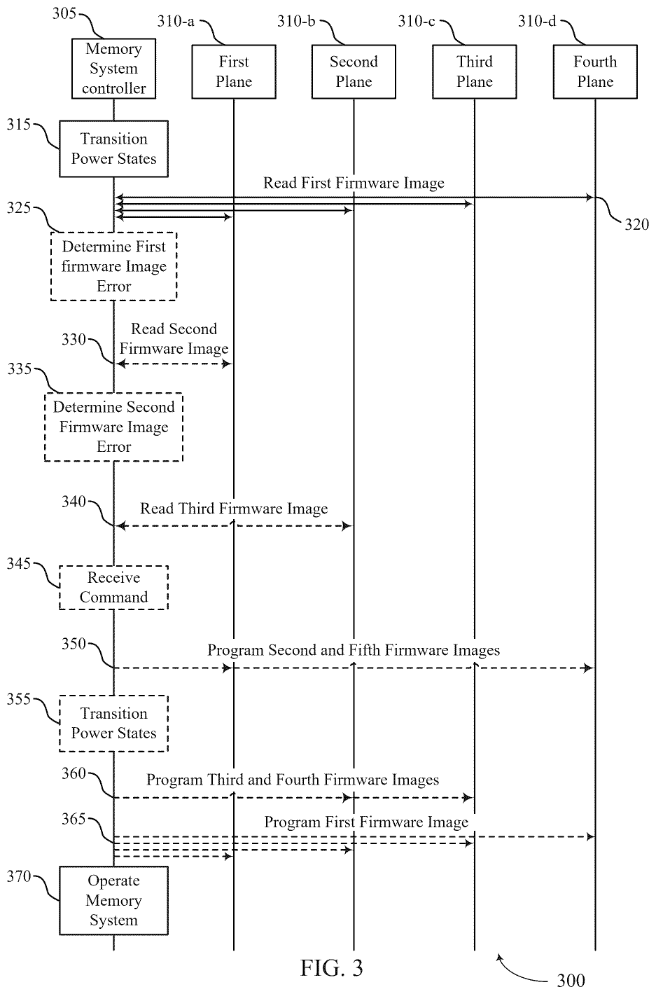

FIG. 3 shows an example of a process 300 that supports multi-plane firmware image management in accordance with examples as disclosed herein. Aspects of the process 300 may implement, or be implemented by, aspects of the system 100, the firmware image configuration 200, or both. For example, the process 300 may illustrate the various accesses and configurations that enable a memory system to store a firmware image across multiple planes of memory such that, during a power-on or boot-up process, the memory system may quickly access and read the stored firmware image from the planes.

The process 300 illustrates aspects performed at or by a memory system controller 305, a first plane 310-a, a second plane 310-b, a third plane 310-c, and a fourth plane 310-d, which may be examples of a memory system controller 115, a first plane 205-a, a second plane 205-b, a third plane 205-c, and a fourth plane 205-d, respectively, as illustrated in FIGS. 1 and 2.

In some examples, the operations illustrated in process 300 may be performed by hardware (e.g., including circuitry, processing blocks, logic components, and other components), code such as processor-executable code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 315, the memory system may transition power states. In some examples, the memory system controller 305 may transition power states of the memory system. For example, during a boot operation (e.g., a boot-up, power-on) operation, the memory system controller 305 may transition the memory system from a first power state to a second power state. In some examples, the first power state may be a powered-off state and the second power state may be a powered-on state. In some other examples, the first power state may be or may refer to a relatively low power state, such as a powered-off state, and the second power state may be or may refer to a relatively higher power state, such as a powered-on state.

At 320, a first firmware image may be read. In some examples, the memory system controller 305 may read a first firmware image that is stored to two or more planes 310 of the memory system. For example, in response to transitioning the memory system from the first power state to the second power state, the memory system controller 305 may read a first firmware image (e.g., a primary firmware image) that is stored to the first plane 310-a, the second plane 310-b, the third plane 310-c, and the fourth plane 310-d of the memory system. That is, the memory system controller 305 may read the first firmware image using a multi-plane read.

In some examples, the first plane 310-a and the second plane 310-b may each be associated with a first memory die of the memory system, and the third plane 310-c and the fourth plane 310-d may each be associated with a second memory die of the memory system. In some examples, the first firmware image may be stored to more than the first plane 310-a, the second plane 310-b, the third plane 310-c, and the fourth plane 310-d of the memory system.

At 325, a first firmware image error may be determined. For example, the memory system controller 305 may determine whether the first firmware image includes an error. Based on reading the first firmware image, the memory system controller 305 may determine whether the first firmware image satisfies an error threshold (e.g., whether the first firmware image includes an error). If the memory system controller 305 determines that the first firmware image satisfies the error threshold, the memory system controller 305 may operate the memory system according to (e.g., using) the first firmware image (e.g., at 370). If the memory system controller 305 determines that the first firmware image does not satisfy the error threshold, the memory system controller 305 may read the second firmware image (e.g., at 330). That is, if the first firmware image fails to satisfy the error threshold (e.g., includes an uncorrectable error), the memory system controller 305 may load (e.g., read) one or more backup copies of the firmware image.

At 330, the second firmware image may be read. For example, the memory system controller 305 may read the second firmware image. Based on the memory system controller 305 determining that the first firmware image does not satisfy the error threshold (e.g., includes at least one error), the memory system controller 305 may read the second firmware image stored to the first plane 310-a of the memory system.

At 335, a second firmware image error may be determined. For example, the memory system controller 305 may determine whether the second firmware image includes an error. Based on reading the second firmware image, the memory system controller 305 may determine whether the second firmware image satisfies an error threshold (e.g., whether the second firmware image includes an error). If the memory system controller 305 determines that the second firmware image satisfies the error threshold, the memory system controller 305 may operate the memory system according to (e.g., using) the second firmware image (e.g., at 370). If the memory system controller 305 determines that the second firmware image does not satisfy the error threshold, the memory system controller 305 may read the third firmware image (e.g., at 340).

At 340, the third firmware image may be read. For example, the memory system controller 305 may read the third firmware image. Based on the memory system controller 305 determining that the second firmware image does not satisfy an error threshold (e.g., includes at least one error), the memory system controller 305 may read the third firmware image stored to the second plane 310-b of the memory system.

At 345, a command may be received. For example, the memory system controller 305 may receive a command from a host system. In some examples, the command may indicate an update to the first firmware image.

At 350, the second and fifth firmware images may be programmed. For example, the memory system controller 305 may program the second firmware image and the fifth firmware image. Based on receiving the command indicating an update to the first firmware image, the memory system controller 305 may program the second firmware image stored to the first plane 310-a and the fifth firmware image stored to the fourth plane 310-d. In some examples, programming the second firmware image and the fifth firmware image may include updating the second firmware image and the fifth firmware image with data associated with the command (e.g., sent by the host system). Additionally, programming the second firmware image and the fifth firmware image may also include storing placeholder data (e.g., padding, dummy data) to the first plane 310-a, the fourth plane 310-d, or both, based on updating the second firmware image and the fifth firmware image.

At 355, a power state transition may be performed. For example, the memory system controller 305 may transition power states of the memory system. Based on programming the second firmware image and the fifth firmware image, the memory system controller 305 may transition the power state of the memory system from the second power state to the first power state and back to the second power state (e.g., may restart the memory system). In some examples, the first power state may be or may refer to a relatively low power state, such as a powered-off state, and the second power state may be or may refer to a relatively higher power state, such as a powered-on state.

At 360, the third and fourth firmware images may be programmed. For example, the memory system controller 305 may program the third firmware image and the fourth firmware image. Based on transitioning the memory system back to the second power state, the memory system controller 305 may program the third firmware image stored to the second plane 310-b and the fourth firmware image stored to the third plane 310-c. In some examples, programming the third firmware image and the fourth firmware image may include updating the third firmware image and the fourth firmware image with data associated with the command (e.g., sent by the host system). Additionally, programming the third firmware image and the fourth firmware image may also include storing placeholder data (e.g., padding, dummy data) to the second plane 310-b, the third plane 310-c, or both, based on updating the third firmware image and the fourth firmware image.

At 365, the first firmware image may be programmed. For example, the memory system controller 305 may program the first firmware image. Based on programming the second firmware image, the third firmware image, the fourth firmware image, and the fifth firmware image, the memory system controller 305 may program the first firmware image. In some examples, programming the first firmware image may include the memory system controller 305 updating the first portion of the first firmware image stored to the first plane 310-a, the second portion of the first firmware image stored to the second plane 310-b, the third portion of the first firmware image stored to the third plane 310-c, and the fourth portion of the first firmware image stored to the fourth plane 310-d.

At 370, the memory system may be operated. For example, the memory system controller 305 may operate the memory system. In response to reading the first firmware image (e.g., at 320) and determining that the first firmware image satisfies the error threshold (e.g., at 325), the memory system controller 305 may operate the memory system according to (e.g., using) the first firmware image. In some other examples, the memory system controller 305 may operate the memory system according to (e.g., using) the second firmware image. For example, response to reading the second firmware image (e.g., at 330) and determining that the second firmware image satisfies the error threshold (e.g., at 335), the memory system controller 305 may operate the memory system according to the second firmware image. In some other examples, the memory system controller 305 may operate the memory system according to (e.g., using) the third firmware image. For example, response to reading the third firmware image (e.g., at 340) and determining that the third firmware image satisfies the error threshold, the memory system controller 305 may operate the memory system according to (e.g., using) the third firmware image. In the case that the memory system controller 305 may determine that the third firmware image does not satisfy the error threshold, the memory system controller 305 may operate the memory system according to the next firmware image that may satisfy the error threshold (e.g., the fourth firmware image, the fifth firmware image).

By storing the first firmware image across the planes 310, the memory system controller 305 (e.g., the memory system) may quickly access and read the first firmware image from the planes 310 during a boot-up or power-on operation, which may reduce the latency associated with a boot-up or power-on procedure and improve the overall performance of the associated memory system. Additionally, by storing copies of the first firmware image (e.g., the second firmware image, the third firmware image, the fourth firmware image, the fifth firmware image) to respective planes 310, the memory system controller 305 may be able to continue operations in the case that the first firmware image may include an error or during a reprogramming operation.

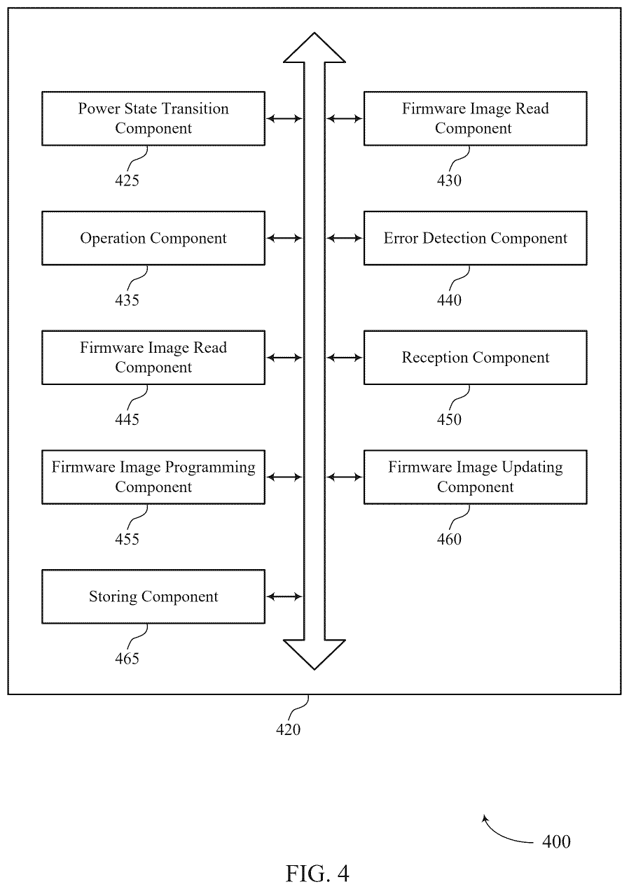

FIG. 4 shows a block diagram 400 of a memory system 420 that supports multi-plane firmware image management in accordance with examples as disclosed herein. The memory system 420 may be an example of aspects of a memory system as described with reference to FIGS. 1 through 3. The memory system 420, or various components thereof, may be an example of means for performing various aspects of multi-plane firmware image management as described herein. For example, the memory system 420 may include a power state transition component 425, a firmware image read component 430, an operation component 435, an error detection component 440, a firmware image read component 445, a reception component 450, a firmware image programming component 455, a firmware image updating component 460, a storing component 465, or any combination thereof. Each of these components, or components of subcomponents thereof (e.g., one or more processors, one or more memories), may communicate, directly or indirectly, with one another (e.g., via one or more buses).

The power state transition component 425 may be configured as or otherwise support a means for transitioning, by the memory device, from a first power state to a second power state, where transitioning from the first power state to the second power state occurs during a boot operation. The firmware image read component 430 may be configured as or otherwise support a means for reading, based at least in part on transitioning from the first power state to the second power state, a first firmware image that is stored to two or more planes of the memory device. The operation component 435 may be configured as or otherwise support a means for operating, based at least in part on reading the first firmware image, the memory device according to the first firmware image.

In some examples, the error detection component 440 may be configured as or otherwise support a means for determining, based at least in part on reading the first firmware image, whether the first firmware image contains an error, where operating the memory device according to the first firmware image is based at least in part on determining that the first firmware image satisfies an error threshold.

In some examples, the firmware image read component 445 may be configured as or otherwise support a means for reading, based at least in part on determining that the first firmware image does not satisfy the error threshold, a second firmware image that is stored to a first plane of the memory device. In some examples, the operation component 435 may be configured as or otherwise support a means for operating, based at least in part on reading the second firmware image, the memory device according to the second firmware image.

In some examples, the error detection component 440 may be configured as or otherwise support a means for determining, based at least in part on reading the second firmware image, that the second firmware image does not satisfy the error threshold. In some examples, the firmware image read component 445 may be configured as or otherwise support a means for reading, based at least in part on determining that the second firmware image does not satisfy the error threshold, a third firmware image that is stored to a second plane of the memory device. In some examples, the operation component 435 may be configured as or otherwise support a means for operating, based at least in part on reading the third firmware image, the memory device according to the third firmware image.

In some examples, the two or more planes include a first plane, a second plane, a third plane, and a fourth plane. In some examples, a second firmware image is stored to the first plane, a third firmware image is stored to the second plane, a fourth firmware image is stored to the third plane, and a fifth firmware image is stored to the fourth plane.

In some examples, the reception component 450 may be configured as or otherwise support a means for receiving, from a host system, a command indicating an update to the first firmware image. In some examples, the firmware image programming component 455 may be configured as or otherwise support a means for programming, based at least in part on receiving the command, the second firmware image and the fifth firmware image. In some examples, the power state transition component 425 may be configured as or otherwise support a means for transitioning, by the memory device and based at least in part on programming the second firmware image and the fifth firmware image, from the second power state to the first power state and back to the second power state. In some examples, the firmware image programming component 455 may be configured as or otherwise support a means for programming, based at least in part on transitioning back to the second power state, the third firmware image and the fourth firmware image. In some examples, the firmware image programming component 455 may be configured as or otherwise support a means for programming the first firmware image based at least in part on programming the second firmware image, the third firmware image, the fourth firmware image, and the fifth firmware image.

In some examples, to support programming the second firmware image, the third firmware image, the fourth firmware image, and the fifth firmware image, the firmware image updating component 460 may be configured as or otherwise support a means for updating the second firmware image, the third firmware image, the fourth firmware image, and the fifth firmware image with data associated with the command. In some examples, to support programming the second firmware image, the third firmware image, the fourth firmware image, and the fifth firmware image, the storing component 465 may be configured as or otherwise support a means for storing placeholder data to one or more of the first plane, the second plane, the third plane, and the fourth plane based at least in part on updating the second firmware image, the third firmware image, the fourth firmware image, and the fifth firmware image.

In some examples, the first firmware image, the second firmware image, the third firmware image, the fourth firmware image, and the fifth firmware image include identical data.

In some examples, to support reading the first firmware image, the firmware image read component 445 may be configured as or otherwise support a means for reading a first portion of the first firmware image from the first plane. In some examples, to support reading the first firmware image, the firmware image read component 445 may be configured as or otherwise support a means for reading, based at least in part on reading the first portion of the first firmware image from the first plane, a second portion of the first firmware image from the second plane. In some examples, to support reading the first firmware image, the firmware image read component 445 may be configured as or otherwise support a means for reading, based at least in part on reading the second portion of the first firmware image from the second plane, a third portion of the first firmware image from the third plane. In some examples, to support reading the first firmware image, the firmware image read component 445 may be configured as or otherwise support a means for reading, based at least in part on reading the third portion of the first firmware image from the third plane, a fourth portion of the first firmware image from the fourth plane.

In some examples, the first firmware image is stored to at least a first plane, a second plane, a third plane, and a fourth plane of the memory device. In some examples, the first plane and the second plane are each associated with a first memory die and the third plane and the fourth plane are each associated with a second memory die.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

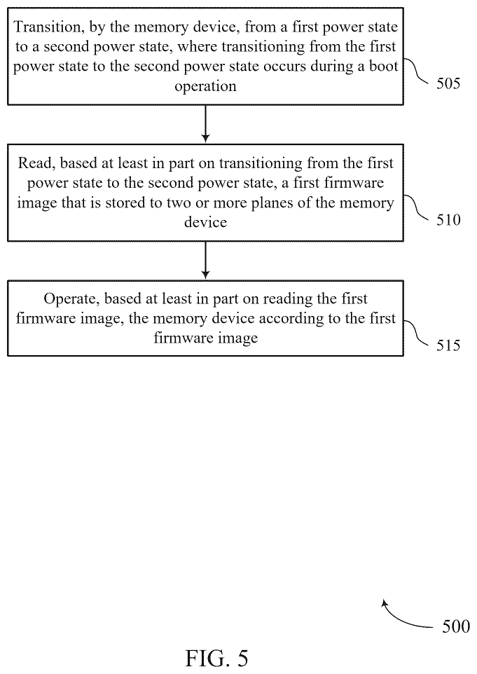

FIG. 5 shows a flowchart illustrating a method 500 that supports multi-plane firmware image management in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include transitioning, by the memory device, from a first power state to a second power state, where transitioning from the first power state to the second power state occurs during a boot operation. In some examples, aspects of the operations of 505 may be performed by a power state transition component 425 as described with reference to FIG. 4.

At 510, the method may include reading, based at least in part on transitioning from the first power state to the second power state, a first firmware image that is stored to two or more planes of the memory device. In some examples, aspects of the operations of 510 may be performed by a firmware image read component 430 as described with reference to FIG. 4.

At 515, the method may include operating, based at least in part on reading the first firmware image, the memory device according to the first firmware image. In some examples, aspects of the operations of 515 may be performed by an operation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transitioning, by the memory device, from a first power state to a second power state, where transitioning from the first power state to the second power state occurs during a boot operation; reading, based at least in part on transitioning from the first power state to the second power state, a first firmware image that is stored to two or more planes of the memory device; and operating, based at least in part on reading the first firmware image, the memory device according to the first firmware image.

Aspect 2: The method, apparatus, or non-transitory computer-readable medium of aspect 1, further including operations, features, circuitry, logic, means, or instructions, or any combination thereof for determining, based at least in part on reading the first firmware image, whether the first firmware image contains an error, where operating the memory device according to the first firmware image is based at least in part on determining that the first firmware image satisfies an error threshold.

Aspect 3: The method, apparatus, or non-transitory computer-readable medium of aspect 2, further including operations, features, circuitry, logic, means, or instructions, or any combination thereof for reading, based at least in part on determining that the first firmware image does not satisfy the error threshold, a second firmware image that is stored to a first plane of the memory device and operating, based at least in part on reading the second firmware image, the memory device according to the second firmware image.

Aspect 4: The method, apparatus, or non-transitory computer-readable medium of aspect 3, further including operations, features, circuitry, logic, means, or instructions, or any combination thereof for determining, based at least in part on reading the second firmware image, that the second firmware image does not satisfy the error threshold; reading, based at least in part on determining that the second firmware image does not satisfy the error threshold, a third firmware image that is stored to a second plane of the memory device; and operating, based at least in part on reading the third firmware image, the memory device according to the third firmware image.

Aspect 5: The method, apparatus, or non-transitory computer-readable medium of any of aspects 1 through 4, where the two or more planes include a first plane, a second plane, a third plane, and a fourth plane and a second firmware image is stored to the first plane, a third firmware image is stored to the second plane, a fourth firmware image is stored to the third plane, and a fifth firmware image is stored to the fourth plane.

Aspect 6: The method, apparatus, or non-transitory computer-readable medium of aspect 5, further including operations, features, circuitry, logic, means, or instructions, or any combination thereof for receiving, from a host system, a command indicating an update to the first firmware image; programming, based at least in part on receiving the command, the second firmware image and the fifth firmware image; transitioning, by the memory device and based at least in part on programming the second firmware image and the fifth firmware image, from the second power state to the first power state and back to the second power state; programming, based at least in part on transitioning back to the second power state, the third firmware image and the fourth firmware image; and programming the first firmware image based at least in part on programming the second firmware image, the third firmware image, the fourth firmware image, and the fifth firmware image.

Aspect 7: The method, apparatus, or non-transitory computer-readable medium of aspect 6, where programming the second firmware image, the third firmware image, the fourth firmware image, and the fifth firmware image includes operations, features, circuitry, logic, means, or instructions, or any combination thereof for updating the second firmware image, the third firmware image, the fourth firmware image, and the fifth firmware image with data associated with the command and storing placeholder data to one or more of the first plane, the second plane, the third plane, and the fourth plane based at least in part on updating the second firmware image, the third firmware image, the fourth firmware image, and the fifth firmware image.

Aspect 8: The method, apparatus, or non-transitory computer-readable medium of any of aspects 5 through 7, where the first firmware image, the second firmware image, the third firmware image, the fourth firmware image, and the fifth firmware image include identical data.

Aspect 9: The method, apparatus, or non-transitory computer-readable medium of any of aspects 1 through 8, where reading the first firmware image includes operations, features, circuitry, logic, means, or instructions, or any combination thereof for reading a first portion of the first firmware image from the first plane; reading, based at least in part on reading the first portion of the first firmware image from the first plane, a second portion of the first firmware image from the second plane; reading, based at least in part on reading the second portion of the first firmware image from the second plane, a third portion of the first firmware image from the third plane; and reading, based at least in part on reading the third portion of the first firmware image from the third plane, a fourth portion of the first firmware image from the fourth plane.

Aspect 10: The method, apparatus, or non-transitory computer-readable medium of any of aspects 1 through 9, where the first firmware image is stored to at least a first plane, a second plane, a third plane, and a fourth plane of the memory device and the first plane and the second plane are each associated with a first memory die and the third plane and the fourth plane are each associated with a second memory die.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device, comprising:
one or more memory arrays; and
processing circuitry coupled with the one or more memory arrays and configured to cause the memory device to:
transition, by the memory device, from a first power state to a second power state, wherein transitioning from the first power state to the second power state occurs during a boot operation;
read, based at least in part on transitioning from the first power state to the second power state, a first firmware image that is stored to two or more planes of the memory device; and
operate, based at least in part on reading the first firmware image, the memory device according to the first firmware image.

2. The memory device of claim 1, wherein the processing circuitry is further configured to cause the memory device to:
determine, based at least in part on reading the first firmware image, whether the first firmware image contains an error, wherein operating the memory device according to the first firmware image is based at least in part on determining that the first firmware image satisfies an error threshold.

3. The memory device of claim 2, wherein the processing circuitry is further configured to cause the memory device to:
read, based at least in part on determining that the first firmware image does not satisfy the error threshold, a second firmware image that is stored to a first plane of the memory device; and
operate, based at least in part on reading the second firmware image, the memory device according to the second firmware image.

4. The memory device of claim 3, wherein the processing circuitry is further configured to cause the memory device to:
determine, based at least in part on reading the second firmware image, that the second firmware image does not satisfy the error threshold;
read, based at least in part on determining that the second firmware image does not satisfy the error threshold, a third firmware image that is stored to a second plane of the memory device; and
operate, based at least in part on reading the third firmware image, the memory device according to the third firmware image.

5. The memory device of claim 1, wherein the two or more planes comprise a first plane, a second plane, a third plane, and a fourth plane, a second firmware image is stored to the first plane, a third firmware image is stored to the second plane, a fourth firmware image is stored to the third plane, and a fifth firmware image is stored to the fourth plane.

6. The memory device of claim 5, wherein the processing circuitry is further configured to cause the memory device to:
receive, from a host system, a command indicating an update to the first firmware image;
program, based at least in part on receiving the command, the second firmware image and the fifth firmware image;
transition, by the memory device and based at least in part on programming the second firmware image and the fifth firmware image, from the second power state to the first power state and back to the second power state;
program, based at least in part on transitioning back to the second power state, the third firmware image and the fourth firmware image; and
program the first firmware image based at least in part on programming the second firmware image, the third firmware image, the fourth firmware image, and the fifth firmware image.

7. The memory device of claim 6, wherein, to program the second firmware image, the third firmware image, the fourth firmware image, and the fifth firmware image, the processing circuitry configured to cause the memory device to:
update the second firmware image, the third firmware image, the fourth firmware image, and the fifth firmware image with data associated with the command; and
store placeholder data to one or more of the first plane, the second plane, the third plane, and the fourth plane based at least in part on updating the second firmware image, the third firmware image, the fourth firmware image, and the fifth firmware image.

8. The memory device of claim 5, wherein the first firmware image, the second firmware image, the third firmware image, the fourth firmware image, and the fifth firmware image comprise identical data.

9. The memory device of claim 1, wherein the first firmware image is stored to a first plane, a second plane, a third plane, and a fourth plane of the two or more planes, wherein to read the first firmware image the processing circuitry configured to cause the memory device to:
read a first portion of the first firmware image from the first plane;
read, based at least in part on reading the first portion of the first firmware image from the first plane, a second portion of the first firmware image from the second plane;
read, based at least in part on reading the second portion of the first firmware image from the second plane, a third portion of the first firmware image from the third plane; and
read, based at least in part on reading the third portion of the first firmware image from the third plane, a fourth portion of the first firmware image from the fourth plane.

10. The memory device of claim 1, wherein the first firmware image is stored to at least a first plane, a second plane, a third plane, and a fourth plane of the memory device, and wherein the first plane and the second plane are each associated with a first memory die and the third plane and the fourth plane are each associated with a second memory die.

11. A non-transitory computer-readable medium storing code, the code comprising instructions which, when executed by one or more processors of a memory device, cause the memory device to:
transition, by the memory device, from a first power state to a second power state, wherein transitioning from the first power state to the second power state occurs during a boot operation;
read, based at least in part on transitioning from the first power state to the second power state, a first firmware image that is stored to two or more planes of the memory device; and
operate, based at least in part on reading the first firmware image, the memory device according to the first firmware image.

12. The non-transitory computer-readable medium of claim 11, wherein the instructions, when executed by the one or more processors of the memory device, further cause the memory device to:
determine, based at least in part on reading the first firmware image, whether the first firmware image contains an error, wherein operating the memory device according to the first firmware image is based at least in part on determining that the first firmware image satisfies an error threshold.

13. The non-transitory computer-readable medium of claim 12, wherein the instructions, when executed by the one or more processors of the memory device, further cause the memory device to:
read, based at least in part on determining that the first firmware image does not satisfy the error threshold, a second firmware image that is stored to a first plane of the memory device; and
operate, based at least in part on reading the second firmware image, the memory device according to the second firmware image.

14. The non-transitory computer-readable medium of claim 13, wherein the instructions, when executed by the one or more processors of the memory device, further cause the memory device to:
determine, based at least in part on reading the second firmware image, that the second firmware image does not satisfy the error threshold;
read, based at least in part on determining that the second firmware image does not satisfy the error threshold, a third firmware image that is stored to a second plane of the memory device; and
operate, based at least in part on reading the third firmware image, the memory device according to the third firmware image.

15. The non-transitory computer-readable medium of claim 11, wherein the two or more planes comprise a first plane, a second plane, a third plane, and a fourth plane, a second firmware image is stored to the first plane, a third firmware image is stored to the second plane, a fourth firmware image is stored to the third plane, and a fifth firmware image is stored to the fourth plane.

16. The non-transitory computer-readable medium of claim 15, wherein the instructions, when executed by the one or more processors of the memory device, further cause the memory device to:
receive, from a host system, a command indicating an update to the first firmware image;
program, based at least in part on receiving the command, the second firmware image and the fifth firmware image;
transition, by the memory device and based at least in part on programming the second firmware image and the fifth firmware image, from the second power state to the first power state and back to the second power state;
program, based at least in part on transitioning back to the second power state, the third firmware image and the fourth firmware image; and
program the first firmware image based at least in part on programming the second firmware image, the third firmware image, the fourth firmware image, and the fifth firmware image.

17. The non-transitory computer-readable medium of claim 16, wherein the instructions to program the second firmware image, the third firmware image, the fourth firmware image, and the fifth firmware image, when executed by the one or more processors of the memory device, further cause the memory device to:
update the second firmware image, the third firmware image, the fourth firmware image, and the fifth firmware image with data associated with the command; and
store placeholder data to one or more of the first plane, the second plane, the third plane, and the fourth plane based at least in part on updating the second firmware image, the third firmware image, the fourth firmware image, and the fifth firmware image.

18. The non-transitory computer-readable medium of claim 15, wherein the first firmware image, the second firmware image, the third firmware image, the fourth firmware image, and the fifth firmware image comprise identical data.

19. The non-transitory computer-readable medium of claim 11, wherein the first firmware image is stored to a first plane, a second plane, a third plane, and a fourth plane of the two or more planes, wherein the instructions to read the first firmware image, when executed by the one or more processors of the memory device, further cause the memory device to:
read a first portion of the first firmware image from the first plane;
read, based at least in part on reading the first portion of the first firmware image from the first plane, a second portion of the first firmware image from the second plane;
read, based at least in part on reading the second portion of the first firmware image from the second plane, a third portion of the first firmware image from the third plane; and
read, based at least in part on reading the third portion of the first firmware image from the third plane, a fourth portion of the first firmware image from the fourth plane.

20. The non-transitory computer-readable medium of claim 11, wherein the first firmware image is stored to at least a first plane, a second plane, a third plane, and a fourth plane of the memory device, and wherein the first plane and the second plane are each associated with a first memory die and the third plane and the fourth plane are each associated with a second memory die.

21. A method by a memory device, comprising:
transitioning, by the memory device, from a first power state to a second power state, wherein transitioning from the first power state to the second power state occurs during a boot operation;
reading, based at least in part on transitioning from the first power state to the second power state, a first firmware image that is stored to two or more planes of the memory device; and
operating, based at least in part on reading the first firmware image, the memory device according to the first firmware image.

22. The method of claim 21, further comprising:
determining, based at least in part on reading the first firmware image, whether the first firmware image contains an error, wherein operating the memory device according to the first firmware image is based at least in part on determining that the first firmware image satisfies an error threshold.

23. The method of claim 22, further comprising:
reading, based at least in part on determining that the first firmware image satisfies the error threshold, a second firmware image that is stored to a first plane of the memory device; and
operating, based at least in part on reading the second firmware image, the memory device according to the second firmware image.

24. The method of claim 23, further comprising:
determining, based at least in part on reading the second firmware image, that the second firmware image does not satisfy the error threshold;
reading, based at least in part on determining that the second firmware image does not satisfy the error threshold, a third firmware image that is stored to a second plane of the memory device; and
operating, based at least in part on reading the third firmware image, the memory device according to the third firmware image.

25. The method of claim 21, wherein the two or more planes comprise a first plane, a second plane, a third plane, and a fourth plane, and wherein a second firmware image is stored to the first plane, a third firmware image is stored to the second plane, a fourth firmware image is stored to the third plane, and a fifth firmware image is stored to the fourth plane.
